(19) United States
(12) Patent Application Publication
(10) Pub. No.: US 2026/0256038 A1
(43) Pub. Date: Sep. 3, 2026

(54) VIRTUAL WALL FOR BOUNDED PERFORMANCE OF AUTO-GUIDANCE OF AGRICULTURAL VEHICLES

(71) Applicant: CNH INDUSTRIAL AMERICA LLC, New Holland, PA (US)

(72) Inventors: Abhinav Tripathi, Naperville, IL (US); Aditya Singh, Bolingbrook, IL (US)

(73) Assignee: CNH INDUSTRIAL AMERICA LLC, New Holland, PA (US)

(21) Appl. No.: 19/549,974

(22) Filed: Feb. 25, 2026

Related U.S. Application Data
(60) Provisional application No. 63/765,477, filed on Feb. 28, 2025.

(51) Int. Cl. A01B 69/04; A01D 45/00; G01B 5/16; G06V 20/10; G06V 20/56; G06V 20/58

(52) U.S. Cl. CPC A01B 69/008; A01D 45/00; G01B 5/16; G06V 20/188; G06V 20/58; G06V 20/588

(57) ABSTRACT

A vehicle including a chassis, a tractive element coupled to the chassis, an actuator operatively coupled to the tractive element, a sensor, one or more processors communicably coupled to the actuator, and a computer-readable, non-transitory storage medium containing instructions executable by one or more processors to: receive positional data from the sensor indicating a position of the vehicle and crop rows of a field in which the vehicle operates, compare the position of the vehicle to a virtual wall defined relative to the crop rows, the virtual wall having a minimum wall threshold and a maximum wall threshold, and control the actuator to adjust a steering angle of the tractive element based on the comparison of the position of the vehicle relative to the virtual wall, wherein the steering angle increases as the position of the vehicle moves from the minimum wall threshold to the maximum wall threshold.

### CROSS-REFERENCE TO RELATED PATENT APPLICATIONS

This application claims the benefit of and priority to U.S. Provisional Patent Application No. 63/765,477, filed Feb. 28, 2025, which is incorporated herein by reference in its entirety.

### BACKGROUND

The present disclosure relates generally to vehicles, and more specifically to guidance control of agricultural vehicles.

### SUMMARY

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

In some aspects, the techniques described herein relate to a vehicle including: a chassis; a tractive element coupled to the chassis; an actuator operatively coupled to the tractive element; a sensor; one or more processors communicably coupled to the actuator; and a computer-readable, non-transitory storage medium having instructions that, when executed by the one or more processors, cause the one or more processors to: receive positional data from the sensor indicating a position of the vehicle and a position of one or more crop rows of a field in which the vehicle operates; compare the position of the vehicle to a virtual wall defined relative to the one or more crop rows, the virtual wall having a minimum wall threshold and a maximum wall threshold; and control the actuator to adjust a steering angle of the tractive element based on the comparison of the position of the vehicle relative to the virtual wall having the minimum wall threshold and the maximum wall threshold, wherein the steering angle increases as the position of the vehicle moves from the minimum wall threshold to the maximum wall threshold.

In some aspects, the techniques described herein relate to a vehicle, wherein the maximum wall threshold is dynamically adjusted based on crop density determined by the sensor.

In some aspects, the techniques described herein relate to a vehicle, wherein the one or more processors are configured to: adjust a braking force of the vehicle to decrease a speed of the vehicle as the position of the vehicle moves from the minimum wall threshold to the maximum wall threshold.

In some aspects, the techniques described herein relate to a vehicle, wherein the one or more processors are configured to: disengage the virtual wall, execute an end-of-row turn, and in response to reengaging with a row to be harvested, reengage the virtual wall.

In some aspects, the techniques described herein relate to a vehicle, wherein the one or more processors are configured to: operate the vehicle in an autonomous or semi-autonomous guidance control during harvesting turns.

In some aspects, the techniques described herein relate to a vehicle, wherein a speed of the vehicle is increased during harvesting turns.

In some aspects, the techniques described herein relate to a vehicle, wherein the sensor is an ultrasound sensor configured to emit sound waves to detect plant stalks and determine row spacing based on the detected plant stalks.

In some aspects, the techniques described herein relate to a vehicle, wherein the sensor is a vision sensor configured to identify crop rows and track deviations from a centerline defined between the crop rows, the centerline being a desired trajectory for the vehicle.

In some aspects, the techniques described herein relate to a vehicle, wherein the sensor is a feeler sensor configured to contact crop stalks and provide the positional data based on resistance changes.

In some aspects, the techniques described herein relate to a vehicle, wherein the sensor is configured to detect at least one of a row location, a row height, or a row curvature of crops, and wherein the one or more processors are configured to adjust at least one of the minimum wall threshold or the maximum wall threshold based on the row location, the row height, or the row curvature of the crops.

In some aspects, the techniques described herein relate to a vehicle including: a chassis; a tractive element coupled to the chassis; an actuator operatively coupled to the tractive element; a sensor; one or more processors communicably coupled to the actuator; and a computer-readable, non-transitory storage medium having instructions that, when executed by the one or more processors, cause the one or more processors to: receive, from the sensor, crop data of one or more crop rows of a field in which the vehicle operates, the crop data indicating at least one of a crop density, crop row spacing, or a crop type of the one or more crop rows, receive positional data from the sensor indicating a position of the vehicle in the field; determine a first wall threshold and a second wall threshold of a virtual wall based at least in part on the crop data, the first wall threshold and the second wall threshold defined relative to the one or more crop rows; and transmit a control signal to cause the vehicle to implement a corrective force based on the position of the vehicle being between the first wall threshold and the second wall threshold of the virtual wall.

In some aspects, the techniques described herein relate to a vehicle, wherein the first wall threshold is located at a first distance from a centerline of a crop row of the one or more crop rows, wherein the second wall threshold is located at a second distance the centerline that is greater than the first distance, and wherein the one or more processors are configured to increase a magnitude of the corrective force as the position of the vehicle moves from the first wall threshold to the second wall threshold.

In some aspects, the techniques described herein relate to a vehicle, wherein a magnitude of the corrective force is based on at least one of a speed, an acceleration, a weight, or a momentum of the vehicle.

In some aspects, the techniques described herein relate to a vehicle, wherein the sensor is configured to sense a crop, and the one or more processors are configured to implement the corrective force in response to the sensed crop.

In some aspects, the techniques described herein relate to a vehicle, wherein the corrective force is a first corrective force, and the one or more processors are further configured to implement a second corrective force based on the position of the vehicle being between the first wall threshold and a centerline.

In some aspects, the techniques described herein relate to a vehicle, wherein the second corrective force is less than the first corrective force.

In some aspects, the techniques described herein relate to a method for control of a vehicle, the method including: defining, by one or more processors, based on a detected position of each of a first crop row and a second crop row of a field in which the vehicle operates, a centerline between the first crop row and the second crop row, defining, by the one or more processors, a virtual wall having a minimum wall threshold and a maximum wall threshold relative to the centerline between the first crop row and the second crop row, and implementing, by the one or more processors, a corrective force to adjust an operating parameter of a vehicle based on a position of the vehicle being between the minimum wall threshold and the maximum wall threshold of the virtual wall.

In some aspects, the techniques described herein relate to a method, wherein a magnitude of the corrective force increases as the position of the vehicle moves from the minimum wall threshold to the maximum wall threshold.

In some aspects, the techniques described herein relate to a method, further including: receiving, by the one or more processors, from a sensor, the detected position of each of the first crop row and the second crop row, the sensor being one of an ultrasound sensor, a vision sensor, or a feeler sensor.

In some aspects, the techniques described herein relate to a method, further including: disengaging, by the one or more processors, the virtual wall, and in response to executing a turn and detecting a third crop row and a fourth crop row, reengaging, by the one or more processors, the virtual wall between the third crop row and the fourth crop row.

### BRIEF DESCRIPTION OF THE DRAWINGS

FIG. 1 is a perspective view of an example vehicle, according to an embodiment.

FIG. 2 is a schematic block diagram of the vehicle of FIG. 1, according to an embodiment.

FIG. 3 is a schematic block diagram of the driveline of the vehicle of FIG. 1, according to an embodiment.

FIG. 4 is an illustrative view of a guidance system with virtual walls for preventing excessive deviations of a vehicle, according to an embodiment.

FIG. 5 is a block diagram of the guidance system of FIG. 4, according to an embodiment.

FIG. 6 is a flowchart of a method for control of a vehicle, according to an embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Automated guidance systems for agricultural vehicles, such as combines, sprayers, and tractors, utilize various sensors, including crop feelers, vision-based sensors, and/or ultrasound-based stock sensors, to maintain alignment within crop rows. Traditional control strategies rely on feedback and feedforward control mechanisms to steer the vehicle based on detected deviations from a predefined centerline. However, these systems exhibit limitations when subjected to impulse disturbances, ground slips, or transitions between different curve geometries, often resulting in excessive deviations and, in some cases, row jumping (e.g., skipping over one or more rows instead of maintaining alignment within its designated track).

Conventional solutions to these shortcomings involve increasing the controller's sensitivity to deviations, which may compromise stability and lead to oscillatory behavior. As such, existing systems lack a robust, dynamic correction mechanism that can engage additional control forces in a manner that preserves the integrity of ongoing harvesting operations.

Accordingly, there exists a need for a supplemental control that can seamlessly integrate with existing vehicle guidance controllers to provide additional corrective guidance control (e.g., steering forces) in a manner that mitigates disturbances without destabilizing the system or interfering with harvesting efficiency.

The present disclosure provides a supplemental control system for agricultural vehicle guidance that utilizes a virtual wall bounding approach to improve guidance and row-keeping performance. The system defines a virtual boundary (e.g., along one or more crop rows, a guidance line, etc.) and applies a corrective force (e.g., through one or more control signals to the vehicle's steering system) when the vehicle approaches the virtual boundary, preventing excessive deviation without requiring aggressive controller gains. In some example, the system determines a lateral deviation of the vehicle from a centerline between crop rows and defines one or more virtual walls as regions of lateral deviation bounded by inner (minimum) and outer (maximum) thresholds on each side of the centerline. When the lateral deviation crosses a minimum threshold on a side, the supplemental control begins generating a corrective steering command, and the magnitude of the corrective steering command increases as the deviation moves toward the corresponding maximum threshold.

The virtual wall may include one or more wall parameters. The wall parameters may include, but are in no way limited to, wall location (e.g., a threshold at which corrective forces begin to influence the vehicle's trajectory), wall elasticity (e.g., a magnitude of the corrective force exerted upon the vehicle when it approaches/enters the virtual boundary), gradient of repulsion (e.g., controlling the rate of corrective force increase), damping factor (e.g., reducing oscillations over time), speed adaptation (e.g., adjusting correction strength based on vehicle velocity), crop row spacing sensitivity (e.g., dynamically modifying wall location based on planting variations), time-based persistence (e.g., maintaining corrective force for a set duration to allow minor deviations), directional biasing (e.g., applying asymmetrical corrections to prevent row jumping), curvature sensitivity (e.g., modifying response when transitioning between straight and curved rows), obstacle detection modulation (e.g., adjusting elasticity to avoid abrupt stops near detected obstacles), multi-layered virtual walls (e.g., introducing soft and strong correction zones), steering angle influence (e.g., modifying corrections based on expected trajectory), crop density compensation (e.g., tuning response based on crop density), environmental condition adjustments (e.g., altering elasticity based on soil moisture, wind, or terrain), control effort smoothing (e.g., ensuring seamless integration with the primary controller), predictive correction zone (e.g., preemptively applying corrections before a deviation worsens), and end-of-row transition sensitivity (e.g., dynamically engaging or disengaging the virtual wall during GNSS-based turns), collectively enabling precise row-keeping stability while maintaining harvesting efficiency.

In some embodiments, the systems and methods herein dynamically adjusts location of the vehicle within a field based on vehicle speed, crop row spacing, and other environmental factors. As the virtual elasticity of the wall increases, the systems and methods herein can apply a stronger corrective force (e.g., generates a more aggressive steering instruction), whereas a less virtual elasticity can result in a more gradual correction. The elasticity can be tuned to prevent excessive oscillation or overcorrection. In some embodiments, the elasticity of the virtual wall is represented in software by one or more parameters that define how rapidly the corrective command grows as a function of the lateral deviation between the minimum and maximum thresholds.

In some embodiments, the supplemental control system functions in tandem with the main guidance controller. For example, the supplemental control system can be deactivated when the vehicle is not approaching/entering the predefined virtual wall/boundary, and can activated when the vehicle approaches/enters the predefined virtual wall/boundary. In this way, smooth, non-disruptive corrective actions are provided, which allows for higher-speed harvesting, improved maneuverability in curved or irregularly planted fields, improved end-of-row transitioning, and/or enhanced stability in variable terrain conditions. Such supplemental control functions (e.g., the virtual wall) may be advantageous where the primary guidance system alone struggles to maintain alignment, such as during rapid transitions between straight and curved crop rows or when traversing uneven terrain. The virtual wall may prevent row jumping and significantly reduce the need for manual intervention by the operator.

In some embodiments, the systems and methods herein provide an enhanced vehicle guidance system by introducing a virtual wall-based correction mechanism that may operate independently of the main guidance controller. In some embodiments, the virtual wall may operate as a part of the main guidance controller.

In some embodiments, the system integrates with a crop feeler sensor, wherein the virtual wall is defined based on voltage thresholds received from the crop feeler sensor and corresponding to row boundaries. In some embodiments, a vision-based sensor determines the wall location by mapping pixel coordinates to real-world distances. For sprayers or other vehicles where crop feelers are impractical, an ultrasound sensor mounted on or near the chassis (e.g., to the underside of the chassis) detects plant stalk positions, establishing the virtual boundary accordingly.

In some embodiments, during operation of the vehicle in a field and when the vehicle approaches the virtual boundary due to a deviation, slip event, transition between different curve geometries, and the like, the supplemental control system applies a corrective steering effort (e.g., generates and transmits a steering control signal) proportional to the elasticity parameter to facilitate recentering of the vehicle toward a guidance trajectory. If the virtual elasticity is too high, the vehicle may oscillate between boundaries; if too low, the vehicle may penetrate the boundary. To address the challenges, the systems and methods herein can dynamically optimize or adjust elasticity of the virtual wall to maintain a smooth, controlled response.

In some embodiments, at end-of-row transitions, where GNSS navigation may be employed, the systems and methods herein can temporarily disengage the virtual wall when the vehicle has not re-entered the crop rows and can re-engage the virtual wall upon re-entry of the vehicle into the crop rows. This allows for faster alignment of the header of the vehicle (e.g., if the vehicle is a harvester), reducing crop loss and improving overall efficiency.

In some embodiments, The virtual wall module may also be extended to incorporate speed modulation and independent braking, wherein corrective efforts are distributed between steering adjustments and controlled deceleration to enhance stability further.

### Overall Vehicle

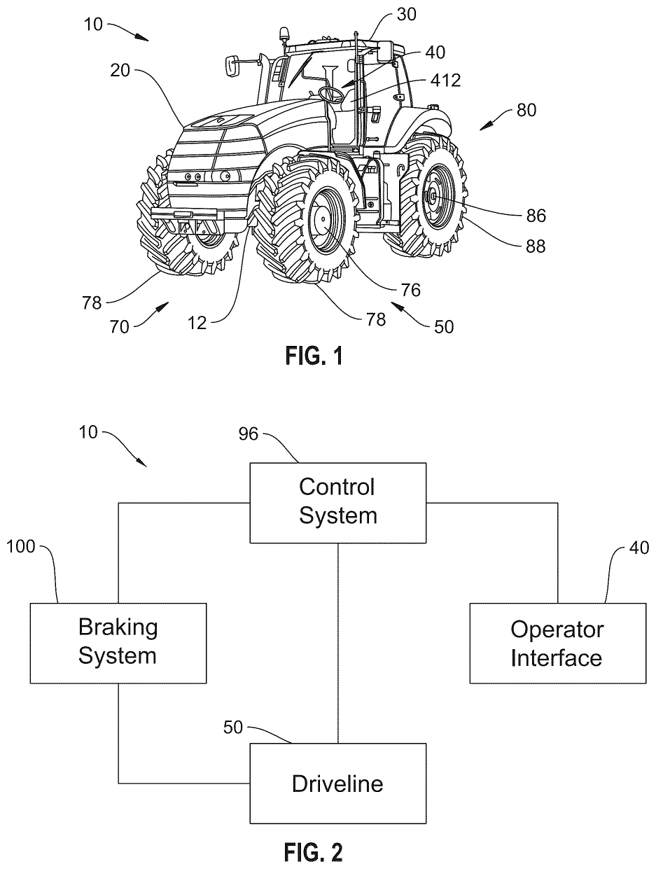

According to the exemplary embodiment shown in FIGS. 1-3, a machine or vehicle (e.g., a non-articulated vehicle, an articulated vehicle, etc.), shown as vehicle 10, includes a chassis, shown as frame 12; a body assembly, shown as body 20, coupled to the frame 12 and having an occupant portion or section, shown as cab 30; operator input and output devices, shown as operator interface 40, that are disposed within the cab 30; a drivetrain, shown as driveline 50, coupled to the frame 12 and at least partially disposed under the body 20; a vehicle braking system, shown as braking system 100, coupled to one or more components of the driveline 50 to facilitate selectively braking the one or more components of the driveline 50; and a vehicle control system, shown as control system 96, coupled to the operator interface 40, the driveline 50, and the braking system 100. In other embodiments, the vehicle 10 includes more or fewer components.

The chassis of the vehicle 10 may include a structural frame (e.g., the frame 12) formed from one or more frame members coupled to one another (e.g., as a weldment). Additionally or alternatively, the chassis may include a portion of the driveline 50. By way of example, a component of the driveline 50 (e.g., the transmission 56) may include a housing of sufficient thickness to provide the component with strength to support other components of the vehicle 10.

According to an exemplary embodiment, the vehicle 10 is an off-road machine or vehicle. In some embodiments, the off-road machine or vehicle is an agricultural machine or vehicle such as a tractor, a telehandler, a front loader, a combine harvester, a grape harvester, a forage harvester, a sprayer vehicle, a speedrower, and/or another type of agricultural machine or vehicle. In some embodiments, the off-road machine or vehicle is a construction machine or vehicle such as a skid steer loader, an excavator, a backhoe loader, a wheel loader, a bulldozer, a telehandler, a motor grader, and/or another type of construction machine or vehicle. In some embodiments, the vehicle 10 includes one or more attached implements and/or trailed implements such as a front mounted mower, a rear mounted mower, a trailed mower, a tedder, a rake, a baler, a plough, a cultivator, a rotavator, a tiller, a harvester, and/or another type of attached implement or trailed implement.

According to an exemplary embodiment, the cab 30 is configured to provide seating for an operator (e.g., a driver, etc.) of the vehicle 10. In some embodiments, the cab 30 is configured to provide seating for one or more passengers of the vehicle 10. According to an exemplary embodiment, the operator interface 40 is configured to provide an operator with the ability to control one or more functions of and/or provide commands to the vehicle 10 and the components thereof (e.g., turn on, turn off, drive, turn, brake, engage various operating modes, raise/lower an implement, etc.). The operator interface 40 may include one or more displays and one or more input devices. The one or more displays may be or include a touchscreen, an LCD display, a LED display, a speedometer, gauges, warning lights, etc. The one or more input device may be or include a steering wheel, a joystick, buttons, switches, knobs, levers, an accelerator pedal, a brake pedal, etc.

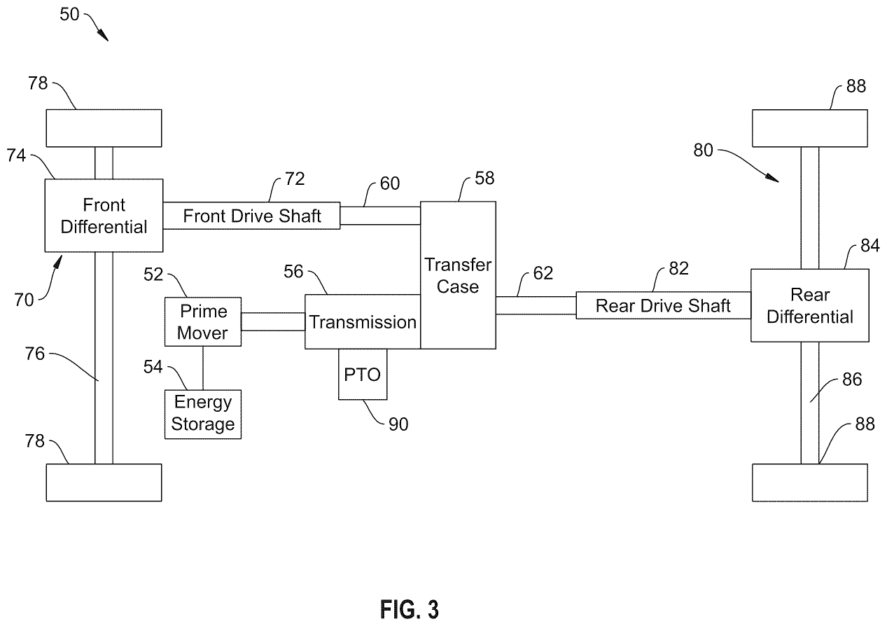

According to an exemplary embodiment, the driveline 50 is configured to propel the vehicle 10. As shown in FIG. 3, the driveline 50 is an electric driveline that includes a primary driver (e.g., prime mover, etc.), shown as prime mover 52, and an energy storage system (e.g., energy storage, etc.), shown as high voltage system 54. For example, the prime mover 52 may be electrically coupled to (e.g., in electrical communication with, etc.) the high voltage system 54 and may consume electrical energy from the high voltage system 54 in order to propel the vehicle 10. In some embodiments, the driveline 50 is a fuel cell electric driveline that includes the prime mover 52 and the energy storage system is a fuel cell (e.g., that stores hydrogen, that produces electricity from the hydrogen, etc.). In some embodiments, the driveline 50 is a hybrid driveline that includes (i) the prime mover 52 and an internal combustion engine and (ii) the high voltage system 54 and a fuel tank. In other embodiments, the driveline 50 is a conventional driveline where the primary driver is an internal combustion engine and the energy storage system is a fuel tank. The internal combustion engine may be a spark-ignition internal combustion engine or a compression-ignition internal combustion engine that may use any suitable fuel type (e.g., diesel, ethanol, gasoline, natural gas, propane, etc.).

As shown in FIG. 3, the driveline 50 includes a transmission device (e.g., a gearbox, a continuous variable transmission (“CVT”), etc.), shown as transmission 56, coupled to the prime mover 52; a power divider, shown as transfer case 58, coupled to the transmission 56; a first tractive assembly, shown as front tractive assembly 70, coupled to a first output of the transfer case 58, shown as front output 60; and a second tractive assembly, shown as rear tractive assembly 80, coupled to a second output of the transfer case 58, shown as rear output 62. According to an exemplary embodiment, the transmission 56 has a variety of configurations (e.g., gear ratios, etc.) and provides different output speeds relative to a mechanical input received thereby from the prime mover 52. In some embodiments (e.g., in electric driveline configurations, in hybrid driveline configurations, etc.), the driveline 50 does not include the transmission 56. In such embodiments, the prime mover 52 may be directly coupled to the transfer case 58. According to an exemplary embodiment, the transfer case 58 is configured to facilitate driving both the front tractive assembly 70 and the rear tractive assembly 80 with the prime mover 52 to facilitate front and rear drive (e.g., an all-wheel-drive vehicle, a four-wheel-drive vehicle, etc.). In some embodiments, the transfer case 58 facilitates selectively engaging rear drive only, front drive only, and both front and rear drive simultaneously. In some embodiments, the transmission 56 and/or the transfer case 58 facilitate selectively disengaging the front tractive assembly 70 and the rear tractive assembly 80 from the prime mover 52 (e.g., to permit free movement of the front tractive assembly 70 and the rear tractive assembly 80 in a neutral mode of operation). In some embodiments, the driveline 50 does not include the transfer case 58. In such embodiments, the prime mover 52 or the transmission 56 may directly drive the front tractive assembly 70 (i.e., a front-wheel-drive vehicle) or the rear tractive assembly 80 (i.e., a rear-wheel-drive vehicle).

As shown in FIGS. 1 and 3, the front tractive assembly 70 includes a first drive shaft, shown as front drive shaft 72, coupled to the front output 60 of the transfer case 58; a first differential, shown as front differential 74, coupled to the front drive shaft 72; a first axle, shown front axle 76, coupled to the front differential 74; and a first pair of tractive elements, shown as front tractive elements 78, coupled to the front axle 76. In some embodiments, the front tractive assembly 70 includes front axles 76. In some embodiments, the front tractive assembly 70 does not include the front drive shaft 72 or the front differential 74 (e.g., a rear-wheel-drive vehicle). In some embodiments, the front drive shaft 72 is directly coupled to the transmission 56 (e.g., in a front-wheel-drive vehicle, in embodiments where the driveline 50 does not include the transfer case 58, etc.) or the prime mover 52 (e.g., in a front-wheel-drive vehicle, in embodiments where the driveline 50 does not include the transfer case 58 or the transmission 56, etc.). The front axle 76 may include one or more components.

As shown in FIGS. 1 and 3, the rear tractive assembly 80 includes a second drive shaft, shown as rear drive shaft 82, coupled to the rear output 62 of the transfer case 58; a second differential, shown as rear differential 84, coupled to the rear drive shaft 82; a second axle, shown rear axle 86, coupled to the rear differential 84; and a second pair of tractive elements, shown as rear tractive elements 88, coupled to the rear axle 86. In some embodiments, the rear tractive assembly 80 includes rear axles 86 (e.g., a plurality). In some embodiments, the rear tractive assembly 80 does not include the rear drive shaft 82 or the rear differential 84 (e.g., a front-wheel-drive vehicle). In some embodiments, the rear drive shaft 82 is directly coupled to the transmission 56 (e.g., in a rear-wheel-drive vehicle, in embodiments where the driveline 50 does not include the transfer case 58, etc.) or the prime mover 52 (e.g., in a rear-wheel-drive vehicle, in embodiments where the driveline 50 does not include the transfer case 58 or the transmission 56, etc.). The rear axle 86 may include one or more components. According to the exemplary embodiment shown in FIG. 1, the front tractive elements 78 and the rear tractive elements 88 are structured as wheels. In other embodiments, the front tractive elements 78 and the rear tractive elements 88 are otherwise structured (e.g., tracks, etc.). In some embodiments, the front tractive elements 78 and the rear tractive elements 88 are both steerable. In other embodiments, only one of the front tractive elements 78 or the rear tractive elements 88 is steerable. In still other embodiments, both the front tractive elements 78 and the rear tractive elements 88 are fixed and not steerable.

In some embodiments, the driveline 50 includes a plurality of the prime mover 52. By way of example, the driveline 50 may include a first of the prime mover 52 that drives the front tractive assembly 70 and a second of the prime mover 52 that drives the rear tractive assembly 80. By way of another example, the driveline 50 may include a first of the prime mover 52 that drives a first one of the front tractive elements 78, a second of the prime mover 52 that drives a second one of the front tractive elements 78, a third of the prime mover 52 that drives a first one of the rear tractive elements 88, and/or a fourth of the prime mover 52 that drives a second one of the rear tractive elements 88. By way of still another example, the driveline 50 may include a first of the prime mover 52 that drives the front tractive assembly 70, a second of the prime mover 52 that drives a first one of the rear tractive elements 88, and a third of the prime mover 52 that drives a second one of the rear tractive elements 88. By way of yet another example, the driveline 50 may include a first of the prime mover 52 that drives the rear tractive assembly 80, a second of the prime mover 52 that drives a first one of the front tractive elements 78, and a third of the prime mover 52 that drives a second one of the front tractive elements 78. In such embodiments, the driveline 50 may not include the transmission 56 and/or the transfer case 58 or may include multiple of the transmissions 56 and/or the transfer cases 58 (e.g., one of the transmissions 56 and/or one of the transfer cases 58 for each of the prime mover 52, etc.).

As shown in FIG. 3, the driveline 50 includes a power-take-off (“PTO”), shown as PTO 90. While the PTO 90 is shown as being an output of the transmission 56, in other embodiments the PTO 90 may be an output of the prime mover 52, the transmission 56, and/or the transfer case 58. According to an exemplary embodiment, the PTO 90 is configured to facilitate driving an attached implement and/or a trailed implement of the vehicle 10. In some embodiments, the driveline 50 includes a PTO clutch positioned to selectively decouple the driveline 50 from the attached implement and/or the trailed implement of the vehicle 10 (e.g., so that the attached implement and/or the trailed implement is only operated when desired, etc.).

According to an exemplary embodiment, the braking system 100 includes one or more brakes (e.g., disc brakes, drum brakes, in-board brakes, axle brakes, etc.) positioned to facilitate selectively braking (i) one or more components of the driveline 50 and/or (ii) one or more components of a trailed implement. In some embodiments, the one or more brakes include (i) one or more front brakes positioned to facilitate braking one or more components of the front tractive assembly 70 and (ii) one or more rear brakes positioned to facilitate braking one or more components of the rear tractive assembly 80. In some embodiments, the one or more brakes include only the one or more front brakes. In some embodiments, the one or more brakes include only the one or more rear brakes. In some embodiments, the one or more front brakes include two front brakes, one positioned to facilitate braking each of the front tractive elements 78. In some embodiments, the one or more front brakes include at least one front brake positioned to facilitate braking the front axle 76. In some embodiments, the one or more rear brakes include two rear brakes, one positioned to facilitate braking each of the rear tractive elements 88. In some embodiments, the one or more rear brakes include at least one rear brake positioned to facilitate braking the rear axle 86. Accordingly, the braking system 100 may include one or more brakes to facilitate braking the front axle 76, the front tractive elements 78, the rear axle 86, and/or the rear tractive elements 88. In some embodiments, the one or more brakes additionally include one or more trailer brakes of a trailed implement attached to the vehicle 10. The trailer brakes are positioned to facilitate selectively braking one or more axles and/or one more tractive elements (e.g., wheels, etc.) of the trailed implement.

### Virtual Wall

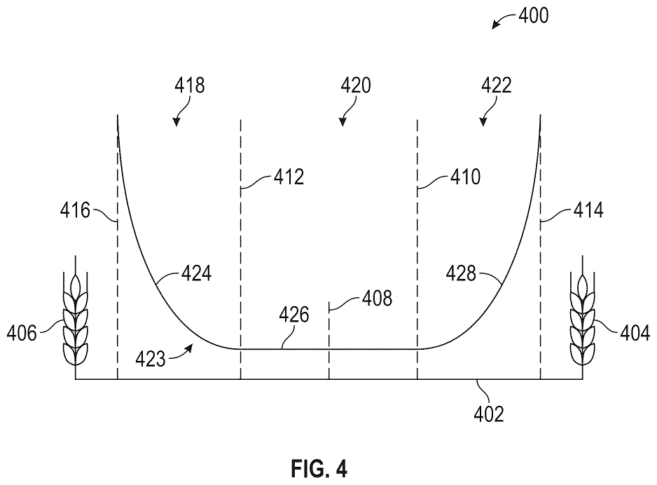

Referring now to FIG. 4, a system (shown as system 400) for guidance control of the vehicle 10 of FIG. 1 is shown. The system 400 may be implemented for guidance (e.g., semi-autonomous, fully autonomous, etc.) of the vehicle 10 in an environment, shown as surface 402 (e.g., a surface of a field in which the vehicle 10 performs agricultural or other operations). In some examples, operations discussed herein with reference to the system 400 can be performed using a computing system (e.g., one or more processors coupled with memory) in combination with other data, elements, or components discussed herein with reference to the system 400. The surface 402 may represent the ground on which the vehicle 10 operates, providing a reference for vehicle 10 position and movement relative to the crop rows. The surface 402 may include a road, field, track, and/or path. The surface may include a slope or other ground texture that may affect the control or movement of the vehicle 10. Topographical mapping or orientation sensing based on the vehicle's orientation due to the topographical changes may be used to adjust corrective forces based on slope or ground texture.

The environment in which the vehicle 10 operates may include one or more crop rows shown as crop row 404 and crop row 406. The crop row 404, 406 may define a physical boundary/waypoint of the field and define the space relative to which the vehicle 10 operates during a portion of harvesting. The system 400 facilitates the vehicle 10 remaining within these boundaries while performing harvesting or other field operations so as to avoid row hopping, row skipping, missed crops, etc. In some implementations, the system 400 may use virtual crop row estimations based on GNSS data (e.g., planting data generated during planting) or pre-mapped field boundaries to supplement or replace direct sensor detection.

The vehicle 10 may include at least one sensor for detecting the crop row 404, 406, or other guidance waypoints. The sensor may be used to detect one or more parameters of the crop row 404, 406 (e.g., row location, row height, row curvature). The crop sensor can detect the position of plants relative to the vehicle's trajectory, allowing the guidance system to maintain alignment between rows. The crop sensor can monitor (e.g., continuously, semi-continuously, at intervals) the edges/stalks of the crop row 404, 406 and provide real-time or near real-time data to the system 400 to adjust steering controls and prevent deviations. The distance to the crop row 404, 406 may be mapped to voltages received/sensed by the sensor based on an engagement of the sensor with the crop row 404, 406. Alternative crop sensors may include mechanical feeler sensors, vision-based cameras, ultrasound sensors, or LiDAR-based detection systems, depending on the crop type, vehicle type, and/or environmental conditions.

A mechanical feeler sensor (e.g., a strain gauge) can physically contact the crop stalks and provides position data based on resistance changes. The feeler sensor may be mounted on a tractive element of the vehicle 10, a harvester element, an implement, etc. A vision-based sensor can utilize cameras and image-processing systems to identify crop row 404, 406 and track deviations from the centerline (e.g., offering a non-contact alternative for structured field environments). An ultrasound sensor can emit sound waves to detect plant stalks and row spacing (e.g., which can be particularly useful in dense canopy conditions where vision-based or feeler systems may struggle to provide accurate readings). A LiDAR sensor can use laser-based ranging to create a detailed 3D map of the crop field (e.g., facilitating navigation in complex terrain).

The system 400 may include centerline 408. The centerline 408 may represent the desired trajectory for the vehicle 10 to remain aligned between the crop row 404, 406 and provide efficient harvesting of the crop row 404, 406. The centerline 408 can serve as the baseline or reference point for defining virtual wall thresholds or for determining when and how corrective forces should be applied. For example, as the vehicle 10 drifts and/or otherwise moves toward crop row 404 or crop row 406 (and consequently away from the centerline 408), the system 400 (e.g., an associated computing system) can generate control signals to transmit to the control system of the vehicle 10. These control signals may include machine-readable instructions that cause the control system of the vehicle 10 to adjust one or more operating parameters (and by extension control elements, such as actuators) that control operation of the vehicle 10 (or coupled implement), such as, but not limited to, steering angle, steering angle rate, vehicle speed, braking force, left braking, right braking, throttle position, wheel slip compensation, suspension damping, hydraulic steering pressure, turn radius adaptation, end-of-row transition speed, row entry angle, sprayer position, and/or header position.

To facilitate vehicle 10 guidance along the centerline 408, the system 400 may include one or more virtual walls, shown as virtual wall 418, 422. The virtual wall 418, 422 may be configured to provide a virtual barrier/region in which to increase the corrective forces applied to the vehicle 10 to prevent excessive deviation from a desired trajectory. The virtual wall 418, 422 may be defined by one or more wall parameters such as, but not limited to, wall location (e.g., one or more thresholds at which corrective forces influence the vehicle's trajectory), wall elasticity (e.g., a magnitude of the corrective force exerted upon the vehicle when it approaches the virtual boundary), gradient of repulsion (e.g., controlling the rate of corrective force increase), damping factor (e.g., reducing oscillations over time), speed adaptation (e.g., adjusting correction strength based on vehicle velocity), crop row spacing sensitivity (e.g., dynamically modifying wall location based on planting variations), time-based persistence (e.g., maintaining corrective force for a set duration to allow minor deviations), directional biasing (e.g., applying asymmetrical corrections to prevent row jumping), curvature sensitivity (e.g., modifying response when transitioning between straight and curved rows), obstacle detection modulation (e.g., adjusting elasticity to avoid abrupt stops near detected obstacles), multi-layered virtual walls (e.g., introducing soft and strong correction zones, a plurality of walls defined between the maximum wall threshold 414 and the maximum wall threshold 416 and the minimum wall threshold 410 and the minimum wall threshold 412, respectively), steering angle influence (e.g., modifying corrections based on expected trajectory), crop density compensation (e.g., tuning response based on crop density), environmental condition adjustments (e.g., altering elasticity based on soil moisture, wind, or terrain), control effort smoothing (e.g., ensuring seamless integration with the primary controller), predictive correction zone (e.g., preemptively applying corrections before a deviation worsens), and end-of-row transition sensitivity (e.g., dynamically engaging or disengaging the virtual wall during GNSS-based turns), collectively or individually facilitating precise row-keeping stability while maintaining harvesting efficiency.

In some embodiments, a sensed or determined crop density is associated with or correlated with a position of the maximum wall threshold 416 of the virtual wall 418 from centerline 408. For example, as the determined crop density increases, the distance of the maximum wall threshold 416 from the centerline 408 may be decreased (e.g., the maximum wall threshold 416 may be positioned closer to centerline 408 when the determined crop density is high, etc.). Similarly, as the crop density decreases, the distance of the maximum wall threshold 416 from the centerline 408 may be increased. As such, the crop density and the distance of the maximum wall threshold 416 from the centerline 408 may be inversely related. In other examples, the crop density and distance of the wall thresholds from the centerline may be used to control wall threshold positioning based on another predefined relationship (e.g., a direct relationship).

In at least one embodiment, the virtual wall 418, 422 is defined by at least one wall position (defined by a minimum wall threshold and a maximum wall threshold, as described herein) and a wall elasticity (e.g., aggressiveness or control rate in redirecting the vehicle 10 upon deviating from the centerline 408).

The system 400 may include wall thresholds (e.g., minimum wall threshold 410, 412 and/or maximum wall threshold 414, 416) that define the position of the virtual wall 418, 422. The maximum wall threshold 414 can define the outermost limits of the virtual wall 422 at which the highest corrective forces (e.g., from a range of corrective forces applied in association with the virtual wall 422) are applied to prevent excessive deviation by the vehicle 10 from the centerline 408. The maximum wall threshold 416 can define the outermost limits of the virtual wall 418 at which the highest corrective forces are applied to prevent excessive deviation by the vehicle 10 from the centerline 408. For example, the maximum wall threshold 414 or the maximum wall threshold 416 may be a predefined distance from the crop row 404 and the crop row 406.

In some embodiments, the sensor may detect or determine the crop row 404 and the crop row 406, and the system 400 can be configured to set the maximum wall threshold 414 and the maximum wall threshold 416 to be the predefined distance from the crop row 404 and the crop row 406, respectively. For example, when the vehicle 10 reaches the maximum wall threshold 414 or the maximum wall threshold 416, the system 400 can apply the strongest corrective force (e.g., most aggressive steering angle used in a range of steering angle corrections associated with the virtual wall, most aggressive speed reduction used in a range of speed reduction corrections associated with the virtual wall, etc.) to redirect the vehicle 10 back toward the centerline 408. In some embodiments, the maximum wall threshold 414 and/or the maximum wall threshold 416 may be dynamically adjusted based on crop density (as determined by the sensor) or environmental factors such as soil conditions or terrain variation to maintain efficient harvesting. In other embodiments, the corrective force may include adjustments to one or more operating parameters of the vehicle 10. For example, the corrective force may include adjusting a steering angle and a speed of the vehicle 10.

In addition, or alternative, to the maximum wall threshold 414, 416, the system 400 may include minimum wall thresholds 410, 412. The minimum wall threshold 410 can define the point (e.g., location in the field from a centerline relative to crop rows) at which supplemented corrective forces (e.g., heighted corrective forces) are generated and transmitted to the control system of the vehicle 10. The system 400 can identify or receive positional data indicating a position of the vehicle 10 relative to the crop rows (e.g., based on sensor data, GPS data, GNSS data, or other location-based information related to the vehicle). As the vehicle 10 moves away from the centerline 408 toward the crop row 404 (as sensed by the sensor), the vehicle 10 can reach the minimum wall threshold 410. Upon receiving an indication from the sensor that the vehicle 10 has reached the minimum wall threshold 410, the system 400 can begin increasing the corrective forces (e.g., steering angle) by way of control signals generated and transmitted to the control system of the vehicle 10. At the minimum wall threshold 410, the supplemental corrective forces are, in some embodiments, gradually increased from the corrective forces implemented when the vehicle 10 is in a region 420 between the minimum wall threshold 410 and the minimum wall threshold 412. This avoids abrupt steering/operating changes, which may lead to a reduced operator experience. As the vehicle 10 proceeds into the virtual wall 422 from the minimum wall threshold 410 toward the maximum wall threshold 414, the system 400 can increase the corrective forces as shown by a corrective force 428. In some embodiments, the corrective forces are increased exponentially (or another relationship such as linearly) as the vehicle 10 proceeds to move in a direction from the minimum wall threshold 410 toward the maximum wall threshold 414.

The corrective forces 428 may represent the amount of corrective force (e.g., steering angle) applied to the vehicle 10 by the system 400 at a particular location of the vehicle 10. In other embodiments, the corrective force 428 may represent a magnitude of an adjustment such as a magnitude of a braking force. As shown and described herein, as the vehicle 10 proceeds closer to the maximum wall threshold 414, the corrective forces 428 can increase, thus preventing the vehicle 10 from row hopping while maintaining a comfortable operation for the operator. It is understood that in embodiments in which the corrective force 428 is a vehicle speed, the corrective forces 428 may decrease as the vehicle 10 approaches the maximum wall threshold 414 (e.g., decreasing the vehicle speed).

In like manner, the system 400 may implement a corrective force 424 within the virtual wall 418 as the vehicle 10 travels from the minimum wall threshold 412 toward the maximum wall threshold 416. The virtual elasticity of the wall may be defined by the shape or a magnitude of the corrective force 428. For example, the higher the corrective force 428, the higher the virtual elasticity of the virtual wall 422. For example, the lower the corrective forces 428, the lower the virtual elasticity of the virtual wall 422. Likewise, for example, the higher the corrective force 424, the higher the virtual elasticity of the virtual wall 418. For example, the lower the corrective force 424, the lower the virtual elasticity of the virtual wall 418.

The shape (e.g., control profile) of the corrective forces 428 may correspond, in part, to one or more parameters of the vehicle 10. These vehicle parameters may include, for example, speed of the vehicle 10, acceleration, weight, momentum, etc. For example, the higher the momentum of the vehicle 10 during travel, the higher the corrective force 428 may be. As described, corrective forces 428 may include decreasing the speed, apply directional braking, etc. In some embodiments, the corrective force 428 may be applied to the vehicle 10 by adjusting one or more actuators (e.g., an actuator operatively coupled to a tractive element of the vehicle 10 to adjust the steering angle of the vehicle 10).

At end-of-row turns/transitions (e.g., when exiting a row to be harvested to turn the vehicle 10 and reinitiate harvesting on a return row), the system 400 may be disengaged (e.g., remove the virtual wall 418, 422 and/or prevent or restrict transmission of control signals generated based on positioning of the vehicle 10 relative to a wall threshold) to allow the vehicle 10 to execute an end-of-row turn. During this disengagement, the vehicle 10 may be navigated manually or by satellite guidance (e.g., GNSS-based navigation, GPS). Once the vehicle 10 has executed the end-of-row turn and reengages with a row to be harvested (e.g., as determined by the sensor engaging with the row, the sensor detecting the rows, or by manual operator input), the system 400 may reengage (e.g., reapply the virtual wall 418, 422 or redefine the virtual wall 418, 422 based on a sensed or detected position of crop rows). In some embodiments, the system 400 is only engaged when the sensor is sensing a crop (e.g., the feeler gauge is sensing a crop). In addition to end-of-row transitions, the system 400 may facilitate increased speeds during auto/semi-auto guidance control during harvesting turns. Because the corrective force 428 increases during operation at/in the virtual wall 422 (e.g., between the minimum wall threshold 410 and the maximum wall threshold 414), as the vehicle 10 travels toward the maximum wall threshold 414, the vehicle 10 is able to travel at greater speeds, because the system 400 dynamically increases correction of the deviation as the vehicle 10 travels further toward the maximum wall threshold 414.

In some embodiments, the full corrective force gradient 423 may include a corrective force 426, which is implemented by the system 400 when the position of the vehicle 10 is between the minimum wall threshold 410 and the minimum wall threshold 412. In some embodiments, the corrective force 426 represents a traditional guidance control without the virtual wall 418, 422.

In embodiments in which the system 400 is implemented when the vehicle 10 is a sprayer, the sensor may be an ultrasound sensor. In embodiments in which the vehicle 10 is a tractor, the sensor may be a vision sensor. In embodiments, in which the vehicle 10 is a combine, the sensor may be a feeler sensor. Various additional combinations of vehicle types and sensor types are contemplated within the scope of the present disclosure.

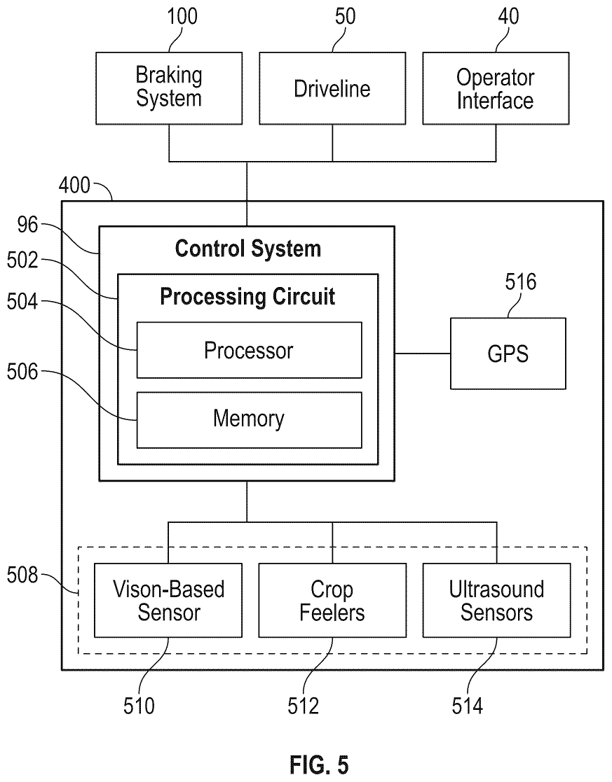

FIG. 5 illustrates a block diagram of the system 400 according to an embodiment. The system 400 includes the control system 96. The control system 96 includes at least one processing circuit 502 having the at least one processor 504 and the at least one memory device 506. The processing circuit 502 may be structured or configured to execute or implement the instructions, commands, and/or control processes described herein with respect to the braking system 100, the driveline 50, or the operator interface 40. However, this illustration is not intended to be limiting, and the present disclosure contemplates other embodiments where the at least one processing circuit 502 is configured as a hardware unit. All such combinations and variations are intended to fall within the scope of the present disclosure.

The at least one processor 504 may be implemented as one or more single-or multi-chip processors, digital signal processors (DSPs), application specific integrated circuits (ASICs), field programmable gate arrays (FPGAs), and/or suitable processors (e.g., other programmable logic devices, discrete hardware components, etc. to perform the functions described herein). A processor may be a microprocessor, a group of processors, etc. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits. Alternatively or additionally, the one or more processors may be structured to perform or otherwise execute certain operations independent of one or more co-processors. In other example embodiments, two or more processors may be coupled via a bus to facilitate independent, parallel, pipelined, or multi-threaded instruction execution. All such variations are intended to fall within the scope of the present disclosure.

The at least one memory device 506 (e.g., memory, memory unit, storage device) may include one or more devices (e.g., RAM, ROM, Flash memory, hard disk storage) for storing data and/or computer code for completing or facilitating the various processes, layers and modules described in the present disclosure. For example, the memory device 506 may include dynamic random-access memory (DRAM). The memory device 506 may be communicably connected to the processor 504 to provide computer code or instructions to the processor 504 for executing at least some of the processes described herein. Moreover, the memory device 506 may be or include tangible, non-transient volatile memory, or non-volatile memory. Accordingly, the memory device 506 may include database components, object code components, script components, or any other type of information structure for supporting the various activities and information structures described herein.

The system 400 can include a sensor array or a plurality of sensors 508. As previously described the plurality of sensors 508 can include at least one of vision-based sensor 510, crop feeler sensors 512, or ultrasound sensors 514, however, the ultrasound sensors 514 is not limited thereto. Each of the plurality of sensors 508 can be configured to determine, detect, or sense operating conditions associated with the terrain or field including, but not limited to, crop density, crop type, plant stalk positions, row spacing, canopy conditions. Each of the plurality of sensors 508 can be communicably coupled to the control system 96. For example, each of the plurality of sensors 508 are configured to provide data or information (e.g., sensed information, etc.) to the control system 96. The control system 96 can be configured is configured to calculate and/or adjust the virtual wall 418 based on the information or data provided by the plurality of sensors 508. In some embodiments, the control system 96 can be configured to control operation of the vehicle based on the information or data provided by the plurality of sensors 508 (e.g., active the braking system 100, control the driveline 50, display a warning on the operator interface 40, etc.).

The system 400 can include a global positioning system (GPS) 516. The GPS 516 can be communicably coupled to the control system 96. The GPS 516 can be configured to detect or determine a position of the vehicle 10 in the field and provide the position to the control system 96. The control system 96 can be configured to determine or set the virtual wall 418 based on each of the data or information provided by the plurality of sensors 508 and the GPS 516. In some examples, the system 400 can include additional and/or alternative positional systems, such as a GNSS system or IMU system, among others.

According to an embodiment, the control system 96 can execute a guidance control loop at a fixed or variable update rate (e.g., multiple times per second or another rate). During each iteration of the control loop, the processing circuit 502 can (i) acquire sensor data from the plurality of sensors 508, (ii) acquire vehicle position and/or orientation data from the GPS 516 and/or other positioning systems, (iii) determine the current guidance centerline 408 based on crop row locations or previously stored guidance paths, and (iv) compute a lateral deviation of the vehicle 10 relative to the centerline 408. The control system 96 then compares this lateral deviation to the minimum wall thresholds 410, 412 and the maximum wall thresholds 414, 416 that define the virtual walls 418, 422.

The at least one memory device 506 can store virtual wall parameters, including the minimum and maximum wall thresholds for each side of the centerline 408 and one or more parameters that define how the corrective forces vary between these thresholds (e.g., a profile of increasing corrective effort from the minimum threshold to the maximum threshold). When the vehicle 10 is within the region between the minimum wall thresholds 410, 412 (e.g., region 420) and not within either virtual wall, the control system 96 can access the virtual wall parameters from the at least one memory device 506 and determine that a supplemental corrective command is not to be provided, thereby allowing a primary guidance controller to control operation. When the vehicle 10 has crossed a minimum wall threshold on one side, the control system 96 can access the virtual wall parameters from the at least one memory device 506, determine that a supplemental corrective command is to be provided, and generate a supplemental corrective command having a magnitude that increases as the vehicle 10 moves closer to the corresponding maximum wall threshold on that side.

In some examples, the supplemental corrective command can be determined by evaluating a predefined relationship or mapping between the vehicle's lateral deviation and the corrective command. For example, the supplemental corrective command may correspond to a magnitude of near zero when the vehicle 10 first enters the virtual wall 418, 422 at the minimum wall threshold and then increase according to a predefined or dynamic function as the vehicle 10 approaches the maximum wall threshold. In some examples, the function may be configured (e.g., shaped) such that small deviations within the virtual wall result in relatively gentle corrections, while larger deviations nearer the maximum wall threshold produce stronger corrections. This relationship or mapping may be configured to be linear, curvilinear, exponential, or otherwise progressively increasing, and may be tuned based on vehicle dynamics, speed, field conditions, or other factors to avoid overshoot and oscillations. The elasticity of the wall can be represented by one or more stored parameter values that map operational parameters of the vehicle to a function that defines an adjustment rate or predefined control signal values for adjusting the corrective effort as the vehicle progresses from the minimum threshold to the maximum threshold.

In some embodiments, the control system 96 can use the virtual wall to adjust one or more vehicle parameters, such as adjusting vehicle steering or speed and/or applying braking. For example, as the vehicle 10 moves deeper into a virtual wall, the control system 96 may reduce a target vehicle speed or command a controlled deceleration to improve stability during the corrective maneuver. The degree of adjustment may increase with the severity of the deviation (e.g., greater reduction near the maximum wall threshold). In some examples, the control system 96 can control multiple (e.g., at least two) vehicle parameters based on the location of the vehicle 10 relative to one or more virtual walls (e.g., a single virtual wall used to control respective operating parameters, layered virtual walls with corresponding or different wall thresholds used to control different respective operating parameters, etc.). In some examples, the control system 96 may prioritize adjustment of one operational parameter over another (e.g., adjusting steering before modifying speed) based on a predefined input, analysis of performance metrics over time, or other factors. In some examples, the control system 96 can provide an alert or other indication (e.g., via a graphical user interface, operator interface, speaker, or other output device) based on whether the vehicle 10 has entered the virtual wall, moved deeper into the virtual wall, or exited the virtual wall.

The virtual wall parameters stored in the memory device 506 may be preconfigured or updated dynamically (e.g., based on sensor inputs, operator preferences, historical performance, changing field conditions, etc.). For example, the control system 96 may adjust the minimum wall threshold (e.g., first wall threshold) and maximum wall threshold (e.g., second wall threshold) or the rate at which corrective effort increases based on estimated crop density, row spacing, vehicle speed, or terrain slope as determined from the plurality of sensors 508 and the GPS 516. In some embodiments, when crop density is high or row spacing is narrow (e.g., based on comparisons with threshold values), the processor 504 may move the maximum wall thresholds 414, 416 closer to the centerline 408 and/or increase the rate of corrective effort growth, thereby tightening the allowable deviation. Conversely, in lower-density or more open conditions, the thresholds may be moved outward or the corrective growth rate reduced to permit a wider operating corridor.

In some examples, the control system 96 may alter the behavior of the virtual wall module during end-of-row transitions. For example, when the GPS 516 and/or the plurality of sensors 508 indicate that the vehicle 10 is approaching an end of a crop row, the control system 96 may temporarily disable or reduce the influence of the virtual wall module to allow the vehicle 10 to execute a turning maneuver under GNSS or manual control. Once the sensors again detect engagement with crop rows corresponding to a new pass, the control system 96 may reinitialize or re-center the virtual walls 418, 422 around a newly established centerline and re-activate the virtual wall corrective control.

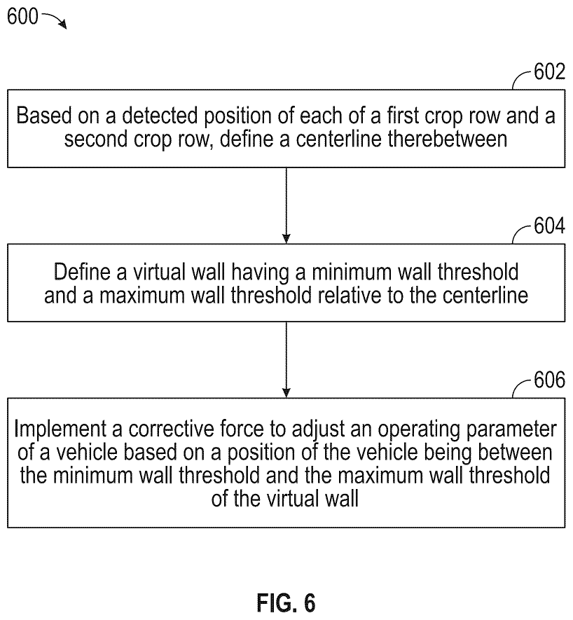

FIG. 6 illustrates a method 600 of controlling the vehicle 10 according to an embodiment. The method 600 can include defining a centerline at operation 602, defining a virtual wall at operation 604, and implementing a corrective force at operation 606. The method 600 can be performed by one or more systems, devices, or components herein (e.g., control system 96, a supplemental guidance system, a virtual wall module, one or more processors, system 400, etc.). In some examples, operations of the method 600 can be added, removed, reordered, and/or otherwise adjusted.

The method 600 can include defining a centerline based on a detected position of each of a first crop row and a second crop row at operation 602. The centerline can be defined therebetween the first and second crop rows to establish a baseline position for detecting deviations of an agricultural or other vehicle (e.g., vehicle 10). For example, one or more processors (e.g., of the control system 96, a virtual wall module, system 400, etc.) can receive information or data from at least one of a plurality of sensors and establish a centerline based on the received information.

The method 600 can include defining a virtual wall having a minimum wall threshold and a maximum wall threshold relative to the centerline at operation 604. In some examples, the one or more processors can define the virtual wall having the minimum wall threshold and the maximum wall threshold based on information received or detected by the plurality of sensors. For example, the one or more processors can define the virtual wall based on at least one of crop type, crop row position, or crop density, and configure the virtual wall so that increased corrective forces are applied as the vehicle moves from a first threshold (e.g., minimum wall threshold) toward a second threshold (e.g., the maximum wall threshold).

The method 600 can include implementing a corrective force to adjust an operating parameter of a vehicle based on a position of the vehicle being between the minimum wall threshold and the maximum wall threshold of the virtual wall at operation 606. For example, the one or more processors can receive information indicative of a position of the vehicle from a positioning system (e.g., a GPS, IMU, GNSS, etc.). Based on the position of the vehicle, the one or more processors can control operation of the vehicle by providing commands or signals to one or more vehicle components (e.g., actuators of braking system, steering control, a driveline, etc.). In some embodiments, the one or more processors can implement a greater corrective force as the position of the vehicle moves closer to the maximum wall threshold of the virtual wall.

In some examples, the method 600 can include dynamically adjusting the maximum wall threshold based on crop density. For example, the one or more processors can determine a crop density from crop data received from one or more sensors (e.g., vision sensors, ultrasound sensors, or feeler sensors) and, in response to detecting a relatively higher crop density, can decrease a distance between the maximum wall threshold and the centerline to tighten an allowable lateral deviation corridor. In one embodiment, the one or more processors can maintain a stored default maximum wall threshold and compute an adjusted threshold by mapping a measured crop density to an offset value (e.g., using a lookup table or rule set that associates density ranges with corresponding threshold offsets). The one or more processors can then update the maximum wall threshold parameter used by the virtual wall module such that subsequent comparisons of vehicle position to the virtual wall reflect the adjusted distance. Conversely, in response to detecting a relatively lower crop density, the one or more processors can increase the distance between the maximum wall threshold and the centerline by applying a different offset, thereby providing a wider allowable deviation range.

In some examples, the method 600 can include adjusting a braking force of the vehicle as the vehicle moves within the virtual wall. For example, the one or more processors can determine a distance of the vehicle from the minimum wall threshold and implement an increase in braking force and/or a reduction in commanded vehicle speed as that distance increases from the minimum wall threshold toward the maximum wall threshold. For example, the one or more processors can compute a deviation value based on the difference between the current lateral position of the vehicle and the minimum wall threshold, and can map this normalized value to a target speed reduction or braking level using a stored relationship (e.g., a mapping table or a monotonic function encoded as software logic). The one or more processors can then generate braking commands for one or more braking actuators or adjust a speed setpoint used by a driveline controller accordingly.

In some examples, the method 600 can include disengaging and reengaging the virtual wall during end-of-row maneuvers. For example, the one or more processors can determine that the vehicle is approaching an end of a crop row based on information received from a positioning system (e.g., a GNSS system) and/or the one or more sensors, and in response can temporarily disengage the virtual wall to permit execution of an end-of-row turn under autonomous, semi-autonomous, or manual guidance. In one embodiment, the one or more processors can compare a current longitudinal position of the vehicle, as determined by the positioning system, to a stored field boundary or row-end coordinate and, when the vehicle is within a predetermined distance of the row end, set a flag or field (e.g., of a data structure) used to activate the virtual wall to an inactive state. While the virtual wall is inactive, the one or more processors can bypass computation of wall-based corrective forces. After the vehicle has executed the turn and the one or more processors detect engagement with one or more new crop rows (e.g., based on sensor-detected crop stalks or vision-based row detection meeting predefined criteria), the one or more processors can reengage the virtual wall by computing a new centerline between the newly detected crop rows, recalculating corresponding minimum and maximum wall thresholds, and setting the virtual wall field or flag back to an active state such that operational adjustments are performed in accordance with the virtual wall.

In some examples, the method 600 can include adapting a guidance mode during harvesting turns. For example, the one or more processors can, during a turn, operate the vehicle in an autonomous or semi-autonomous guidance mode in which steering and speed commands are generated based on a combination of a positioning system, stored turn paths, and/or operator inputs.

In some examples, the method 600 can include defining the virtual wall based on crop data received from the sensor. For example, the one or more processors can receive crop data indicating at least one of a crop density, crop row spacing, or a crop type from one or more sensors and determine a first wall threshold and a second wall threshold of the virtual wall based on that crop data. In one embodiment, the processors can maintain configuration data that associates different crop types or row spacings with recommended threshold distances from the centerline and, upon identifying a particular crop type or row spacing from the crop data, can select or interpolate using those stored values to define the first and second wall thresholds. In some examples, the first wall threshold can be located at a first distance from a centerline of a crop row and the second wall threshold can be located at a second distance from the centerline that is greater than the first distance, and the one or more processors can increase a magnitude of the corrective force as the position of the vehicle moves from the first wall threshold toward the second wall threshold. For example, the one or more processors can evaluate or access a stored relationship that specifies adjustments to corrective efforts based on measured lateral position within a virtual wall interval.

In some examples, the method 600 can include adjusting the corrective force based on one or more vehicle parameters. For example, the one or more processors can determine at least one of a speed, an acceleration, a weight, or a momentum of the vehicle and adjust a rate at which the corrective force increases with distance into the virtual wall based on the determined parameter. For example, the one or more processors can obtain vehicle speed from a wheel speed sensor or driveline controller, estimate acceleration from successive speed measurements or from an inertial measurement unit, and access a stored vehicle weight or load estimate from a configuration database. The processors can then select a corrective-force profile from a lookup table indexed by one or more of such parameters or can compute scaling factors to apply to a base corrective-force profile. In some examples, the one or more processors can increase the rate of corrective force adjustment when the speed or estimated momentum exceeds a threshold, thereby generating stronger corrections for a particular lateral deviation, and can reduce that rate when the speed or momentum is relatively low to reduce abrupt control actions at low energy levels.

In some examples, the method 600 can include implementing multiple corrective forces in different regions between the centerline and the virtual wall thresholds. For example, the one or more processors can determine that the position of the vehicle is between the centerline and the first wall threshold and implement a first corrective force having a first magnitude profile, and can determine that the position of the vehicle is between the first wall threshold and the second wall threshold and implement a second corrective force having a second, greater magnitude profile. In some examples, the processors can compare the current lateral position against both thresholds to determine in which region the vehicle is located and then apply a corresponding control. The first corrective force can be generated using a relatively low gain or shallow gradient relationship between lateral deviation and steering or braking command, such that minor deviations near the centerline are corrected gently. The second corrective force can be generated using a higher gain or steeper gradient relationship, or by invoking a different correction mode that commands larger steering angles or speed reductions for similar deviations, thereby producing stronger corrections in the outer region of the virtual wall.

In some examples, the method 600 can include selectively implementing the virtual wall based on crop detection. For example, the one or more processors can receive crop detection data from a sensor configured to sense a crop (e.g., a feeler sensor contacting crop stalks, an ultrasound sensor detecting plant stalks, or a vision sensor detecting row edges) and can activate or intensify the virtual wall-based corrective force in response to detecting the crop, while deactivating or reducing the virtual wall-based corrective force in the absence of such detection. In one embodiment, the processors can continuously evaluate sensor outputs against one or more detection thresholds or pattern-recognition criteria to determine whether valid crop rows are present within a field of view. When the detection confidence exceeds a predefined level, the one or more processors can set a virtual wall activation state to active and compute full-strength virtual wall corrections. When the detection confidence falls below the level (for example, while traversing headlands or gaps in the crop), the one or more processors can set the activation state to inactive or reduced and either suspend virtual wall corrections or apply a reduced level of correction based primarily on other guidance inputs or controls (e.g., GPS or GNSS, operator control, etc.).

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below,” “left,” “right,” “front,” “back”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more computer-readable, non-transitory storage medium (e.g., RAM, ROM, Flash memory, hard disk storage) for storing data and/or computer code for completing or facilitating the various processes, layers and modules described in the present disclosure. The memory/computer-readable, non-transitory storage medium containing volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof as shown in the various exemplary embodiments is illustrative only. Additionally, any element disclosed in one embodiment may be incorporated or utilized with any other embodiment disclosed herein.

What is claimed is:

1. A vehicle comprising:
a chassis;
a tractive element coupled to the chassis;
an actuator operatively coupled to the tractive element;
a sensor;
one or more processors communicably coupled to the actuator; and
a computer-readable, non-transitory storage medium having instructions that, when executed by the one or more processors, cause the one or more processors to:
receive positional data from the sensor indicating a position of the vehicle and a position of one or more crop rows of a field in which the vehicle operates;
compare the position of the vehicle to a virtual wall defined relative to the one or more crop rows, the virtual wall having a minimum wall threshold and a maximum wall threshold; and
control the actuator to adjust a steering angle of the tractive element based on the comparison of the position of the vehicle relative to the virtual wall having the minimum wall threshold and the maximum wall threshold, wherein the steering angle increases as the position of the vehicle moves from the minimum wall threshold to the maximum wall threshold.

2. The vehicle of claim 1, wherein the maximum wall threshold is dynamically adjusted based on crop density determined by the sensor.

3. The vehicle of claim 1, wherein the one or more processors are configured to:
adjust a braking force of the vehicle to decrease a speed of the vehicle as the position of the vehicle moves from the minimum wall threshold to the maximum wall threshold.

4. The vehicle of claim 1, wherein the one or more processors are configured to:
disengage the virtual wall,
execute an end-of-row turn, and
in response to reengaging with a row to be harvested, reengage the virtual wall.

5. The vehicle of claim 4, wherein the one or more processors are configured to:
operate the vehicle in an autonomous or semi-autonomous guidance control during harvesting turns.

6. The vehicle of claim 5, wherein a speed of the vehicle is increased during harvesting turns.

7. The vehicle of claim 1, wherein the sensor is an ultrasound sensor configured to emit sound waves to detect plant stalks and determine row spacing based on the detected plant stalks.

8. The vehicle of claim 1, wherein the sensor is a vision sensor configured to identify crop rows and track deviations from a centerline defined between the crop rows, the centerline being a desired trajectory for the vehicle.

9. The vehicle of claim 1, wherein the sensor is a feeler sensor configured to contact crop stalks and provide the positional data based on resistance changes.

10. The vehicle of claim 1, wherein the sensor is configured to detect at least one of a row location, a row height, or a row curvature of crops, and wherein the one or more processors are configured to adjust at least one of the minimum wall threshold or the maximum wall threshold based on the row location, the row height, or the row curvature of the crops.

11. A vehicle comprising:
a chassis;
a tractive element coupled to the chassis;
an actuator operatively coupled to the tractive element;
a sensor;
one or more processors communicably coupled to the actuator; and
a computer-readable, non-transitory storage medium having instructions that, when executed by the one or more processors, cause the one or more processors to:
receive, from the sensor, crop data of one or more crop rows of a field in which the vehicle operates, the crop data indicating at least one of a crop density, crop row spacing, or a crop type of the one or more crop rows,
receive positional data from the sensor indicating a position of the vehicle in the field;
determine a first wall threshold and a second wall threshold of a virtual wall based at least in part on the crop data, the first wall threshold and the second wall threshold defined relative to the one or more crop rows; and
transmit a control signal to cause the vehicle to implement a corrective force based on the position of the vehicle being between the first wall threshold and the second wall threshold of the virtual wall.

12. The vehicle of claim 11, wherein the first wall threshold is located at a first distance from a centerline of a crop row of the one or more crop rows, wherein the second wall threshold is located at a second distance the centerline that is greater than the first distance, and wherein the one or more processors are configured to increase a magnitude of the corrective force as the position of the vehicle moves from the first wall threshold to the second wall threshold.

13. The vehicle of claim 11, wherein a magnitude of the corrective force is based on at least one of a speed, an acceleration, a weight, or a momentum of the vehicle.

14. The vehicle of claim 11, wherein the sensor is configured to sense a crop, and the one or more processors are configured to implement the corrective force in response to the sensed crop.

15. The vehicle of claim 11, wherein the corrective force is a first corrective force, and the one or more processors are further configured to implement a second corrective force based on the position of the vehicle being between the first wall threshold and a centerline.

16. The vehicle of claim 15, wherein the second corrective force is less than the first corrective force.

17. A method for control of a vehicle, the method comprising:
defining, by one or more processors, based on a detected position of each of a first crop row and a second crop row of a field in which the vehicle operates, a centerline between the first crop row and the second crop row,
defining, by the one or more processors, a virtual wall having a minimum wall threshold and a maximum wall threshold relative to the centerline between the first crop row and the second crop row, and
implementing, by the one or more processors, a corrective force to adjust an operating parameter of a vehicle based on a position of the vehicle being between the minimum wall threshold and the maximum wall threshold of the virtual wall.

18. The method of claim 17, wherein a magnitude of the corrective force increases as the position of the vehicle moves from the minimum wall threshold to the maximum wall threshold.

19. The method of claim 17, further comprising:
receiving, by the one or more processors, from a sensor, the detected position of each of the first crop row and the second crop row, the sensor being one of an ultrasound sensor, a vision sensor, or a feeler sensor.

20. The method of claim 17, further comprising:
disengaging, by the one or more processors, the virtual wall, and
in response to executing a turn and detecting a third crop row and a fourth crop row, reengaging, by the one or more processors, the virtual wall between the third crop row and the fourth crop row.
